(19) United States
(12) Patent Application Publication
(10) Pub. No.: US 2006/0172582 A1
(43) Pub. Date: Aug. 3, 2006

(54) High-rigidity stainless steel for central processing unit socket frame or central processing unit retention cover

(76) Inventors: Takahiro Fujii, Shunan-shi (JP); Katsunori Babazono, Shunan-shi (JP); Junichi Katsuki, Shunan-shi (JP)

Correspondence Address: CLARK & BRODY, 1090 VERMONT AVENUE, NW, SUITE 250, WASHINGTON, DC, 20005, US

(21) Appl. No.: 11/342,578

(22) Filed: Jan. 31, 2006

(30) Foreign Application Priority Data
Feb. 3, 2005 (JP) JP2005-27269

(51) Int. Cl. H01R 4/50

(52) U.S. Cl. 439/342

(57) ABSTRACT

High-rigidity stainless steel sheet is provided for CPU socket frames or retention covers that are lower in cost and have a better fastening performance compared to conventional ones. The stainless steel sheet has a Young's modulus E_{T} in the T direction that is 210 GPa or above, an 0.2% yield strength σ_{0.2L} in the L direction that is from 500 to 900 MPa, and an 0.2% yield strength σ_{0.2T} in the T direction that is from 600 to 900 MPa, with the L direction being steel sheet rolling direction and the T direction being a direction perpendicular to the rolling direction (that is, a direction perpendicular to both the rolling direction and the sheet thickness direction). In the stainless steel sheet, the relationship between the Young's modulus E_{L} (GPa) in the L direction and the Young's modulus E_{T} (GPa) in the T direction is preferably E_{L}≦E_{T}−15.

### FIELD OF THE INVENTION

The present invention relates to high-rigidity stainless steel sheet for a central processing unit (CPU) socket frame or retention cover for attaching the CPU of a personal computer and the like to a motherboard.

### DESCRIPTION OF THE PRIOR ART

As the speed of personal computer CPUs has risen in recent years, there has been an increase in the number of CPU pins. That has made it necessary to ensure that there is a secure connection between the pins and the board. To achieve that, the material used to constitute the CPU socket frame and cover is undergoing a transition from resin to metal, which offers a more-reliable fastening performance.

FIG. 1 shows a working example of a CPU socket frame 1 and CPU retention cover 2 manufactured of metal. FIG. 1 (a) shows a CPU chip 3 positioned in the CPU socket 4 on the motherboard, but not yet retained. A CPU socket frame 1 formed of pressed metal is connected to the CPU socket 4. A CPU retention cover 2 and hook 5 are attached to the CPU socket 4. The retention cover 2 is formed of pressed metal, and has a catch 6 for engaging with the hook 5. FIG. 1 (b) shows the CPU chip 3 pressed onto the socket 4 by the retention cover 2 and retained there by the engagement of the catch 6 of the retention cover 2 with the hook 5 of the socket 4.

The CPU retention cover 2 is bowed. In the example of FIG. 1 (a), this is a concave warp between the right side of the cover 2, which is the side where the frame-cover coupling section 7 is located, and the left side of the cover 2, which is the side provided with the hook 5. In the state shown in FIG. 1 (b), the CPU chip 3 is securely connected by pressing the retention cover catch 6 into engagement with the socket hook 5, utilizing the restoring force of the warp in a state in which the warp is flattened within the elastic limit.

Conventionally, cold-rolled austenitic stainless steel such as AISI type 301 and type 304 and the like have been used as the metal material of the CPU socket frame 1 and retention cover 2. Austenitic stainless steel can be work-hardened through cold rolling that utilizes strain-induced martensitic transformation, and is in general use as a material for structures such as plate springs and frames and the like.

### OBJECT OF THE INVENTION

Austenitic stainless steel generally contains in the order of 8% by mass nickel, giving it good corrosion resistance, it has the drawback of being costly, due to the high price of the raw materials. Moreover, with electronic devices becoming smaller and lighter, various parts are required to be thinner. Meeting such needs has been generating demand for materials having higher rigidity than conventional materials.

The raw material costs can be reduced by replacing austenitic stainless steel with ferritic or martensitic stainless steel, which have a lower nickel content. Ferritic stainless steel has been developed that is suitable for members such as CRT frames, for example, for which high rigidity is required, as seen in JP 2004-68033 A (Reference No. 1). However, in the case of a CPU socket frame and retention cover whereby the CPU chip is retained pressed into the socket by utilizing the restoring force of warp in a specific direction imparted to the retention cover, a non-austenitic material that is suitable for a CPU socket frame and retention cover having such a function has yet to be developed. Also, CPU socket frames and retention covers are usually manufactured by transfer pressing of strip metal using progressive die forming, so that if the rigidity of the sheet in the threading direction is too high, excessive resistance force, springback-based pressing defects and other such problems can readily occur. Thus, it is not possible to efficiently manufacture a CPU socket frame and retention cover simply by choosing an austenitic steel material.

### SUMMARY OF THE INVENTION

An object of the present invention is to provide low-cost steel sheet that has higher rigidity than conventional austenitic steels and can be used to mass-produce CPU socket frames or CPU retention covers by transfer-pressing.

Detailed studies by the present inventors enabled them to find that it is possible to attain the above object with stainless steel sheet having a Young's modulus that is elevated specifically in a particular direction required for CPU retention. That is, the present invention provides stainless steel sheet for a CPU socket frame or CPU retention cover, said stainless steel sheet having a Young's modulus E_{T} in a T direction that is 210 GPa or above, an 0.2% yield strength σ_{0.2L} in an L direction that is from 500 to 900 MPa, and an 0.2% yield strength σ_{0.2T} in the T direction that is from 600 to 900 MPa, said L direction being the steel sheet rolling direction and said T direction being a direction perpendicular to the rolling direction (that is, a direction perpendicular to both the rolling direction and the sheet thickness direction). In the stainless steel sheet, the relationship between the Young's modulus E_{L} (GPa) in the L direction and the Young's modulus E_{T} (GPa) in the T direction is preferably E_{L}≦E_{T}−15.

The chemical composition of the above steel sheet, in mass percent, is C: up to 0.15%, Si: up to 2%, Mn: up to 1%, Cr: 10 to 20%, Ni: up to 2%, Al: 0.001 to 0.05%, Mo: 0 to 4%, Cu: 0 to 2%, Ti: 0 to 2%, Nb: 0 to 2%, with the balance being Fe and unavoidable impurities. Here, Mo, Cu, Ti and Nb are elements added as desired, with the lower limit 0% being a content that is below the limit of measurements in used in analytical techniques in normal steel manufacturing processes.

This invention has the following advantages.

(1) It makes it possible to provide CPU socket frames and CPU retention covers at a lower cost than before by changing to a non-austenitic steel.

(2) By providing steel sheet having improved rigidity, the fastening performance of the CPU socket frame and of the CPU retention cover is improved, making it possible to handle the needs of CPUs with higher pin counts and thinner CPU socket frames and retention covers.

(3) By elevating the Young's modulus of the steel sheet specifically in a particular direction, it is possible to provide improved product performance based on high rigidity while at the same time ensuring good transfer-pressing manufacturability.

Thus, the invention helps to spread the use of personal computers equipped with high-performance CPUs and to make them smaller and lighter.

### BRIEF EXPLANATION OF THE DRAWING

FIG. 1 is an illustration of a working example of a metal CPU socket frame and retention cover.

### DETAILED DESCRIPTION OF THE INVENTION

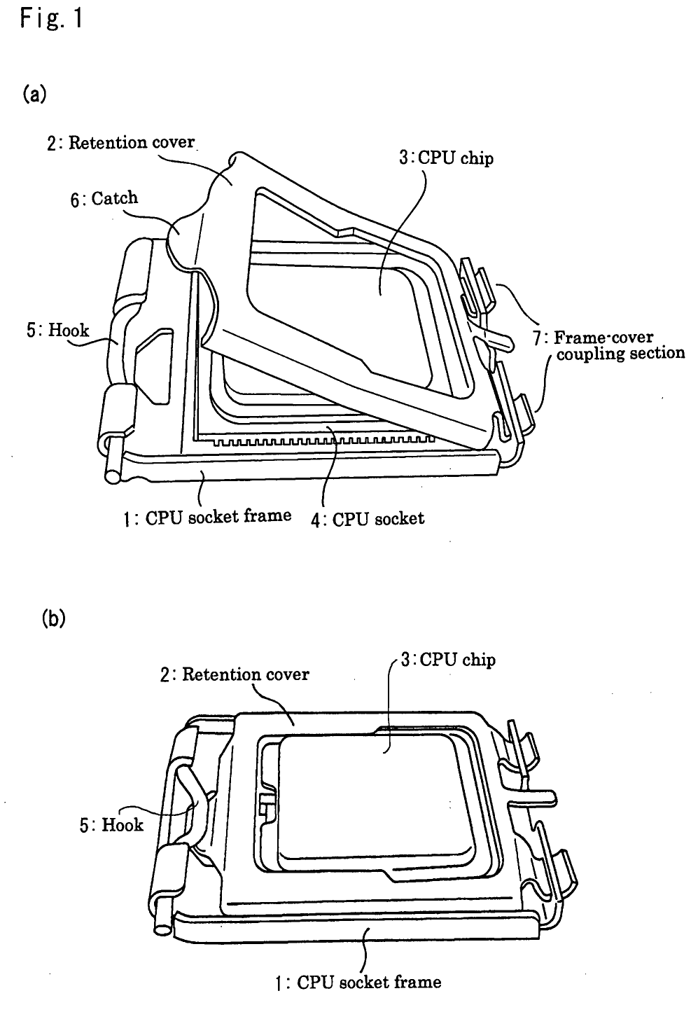

Various studies by the present inventors revealed that to improve the fastening performance of a CPU socket frame and retention cover, it is not necessary to raise the Young's modulus in all directions of the steel sheet concerned; instead, the Young's modulus only needs to be elevated specifically in a certain, fixed direction. With respect to the CPU retention cover, described with reference to the example of FIG. 1 (a), it is important to increase the Young's modulus in the direction in which the side with the frame-cover coupling section 7 and the side with the catch 6 are connected (hereinbelow called the “direction with the warp”). That is, in the state shown in FIG. 1 (b) in which the warp is flattened out, compressive stress and tensile stress within the material of the retention cover are produced at different places in the direction with the warp, and the restoring force comes from these internal stresses. In order for a large restoring force to be generated by the slight elastic deformation of the flattening of the warp, it is necessary to produce large compressive and tensile stresses in the direction with the warp, for which the Young's modulus of the material in the direction concerned has to be increased.

For the CPU socket frame to maintain its original shape as much as possible against the restoring force of the retention cover, again it is necessary to increase the Young's modulus in the side-to-side direction, with respect to FIG. 1 (b).

Taking into consideration the manufacturability of parts formed by transfer pressing, it is important that the Young's modulus in the longitudinal direction (direction of strip progress) of the metal strip not be made too large.

Based on various studies, the present inventors found that in stainless steel having a composition within a specific range, it is possible to control the anisotropy imparted to the Young's modulus by adjusting the finish cold-rolling reduction ratio. That is, it is possible greatly to increase the T-direction Young's modulus compared to that in the L direction. In the invention, this principle is utilized to increase the Young's modulus specifically in the T direction and have the direction in which it is necessary to elevate the Young's modulus to improve the fastening force provided by the CPU socket frame and retention cover coincide with the T direction. With respect to the illustrated example of FIG. 1 (b), the side-to-side direction of the CPU socket frame 1 and of the retention cover 2 are both arranged to be in the T direction. It is possible to suppress excessive increase of the Young's modulus in the L direction, and adequate manufacturability in the transfer pressing process can be ensured with steel strip subjected to such control.

In the following, items for defining the invention are explained.

Young's Modulus

As described in the above, the CPU retention cover is bowed to form the warp and, as shown in FIG. 1 (b), the retention cover 2 is subjected to elastic deformation in the state in which it is locked onto the CPU socket frame 1 by means of the hook 5 thereof. The CPU chip 3 is retained by receiving the restoring force generated by the elastic deformation. Thus, described with reference to the illustration of FIG. 1 (b), the CPU socket frame 1 and retention cover 2 have to have a high Young's modulus in the side-to-side direction to generate a powerful restoring force. In this invention, it is arranged that the direction in which a high Young's modulus is required is the T direction. Based on various studies, it was found that it is possible to stably obtain a fastening pressure able to handle CPUs with higher pin counts when both the CPU socket frame 1 and the retention cover 2 are press-formed from steel sheet in which the Young's modulus E_{T} in the T direction is 210 GPa or above, and preferably 220 GPa or above.

Taking into consideration the transfer press formability of the material, the Young's modulus E_{L} in the L direction should not be excessively high. Specifically, good results were obtained with the relationship E_{L}≦E_{T} −15. On the other hand, too low an E_{L} will have an adverse effect on the balance of the strength of the members. Therefore, preferably the E_{L} is at least 195 GPa, and more preferably is at least 200 GPa.

0.2% Yield Strength

A material may have a high Young's modulus, but if it has a low 0.2% yield strength, in the locked state of FIG. 1 (b) plastic deformation will occur, making it impossible to obtain a sufficient fixing force. From various studies, the present inventors found that, prior to press-forming the CPU socket frame and retention cover, the room-temperature 0.2% yield strength σ_{0.2T} of the steel sheet in the T direction has to be at least 600 MPa, and it is desirable for the 0.2% yield strength in the L direction to be at least 500 MPa. However, in the case of both the L and T directions, if the 0.2% yield strength exceeds 900 MPa the bending workability is degraded, causing cracking during the press-forming. So, when workability is a priority, the L-direction 0.2% yield strength σ_{0.2L} should be kept to 800 MPa or below. When the 0.2% yield strength σ_{0.2L} in the L direction is kept to 800 MPa or below, sufficiently workability is normally ensured even with a T-direction 0.2% yield strength σ_{0.2T} of up to 900 MPa.

Chemical Composition

C is an effective element for achieving a high-strength matrix by strengthening the solid solution, but an excessive C content degrades corrosion resistance by promoting the formation of Cr-based carbides. Therefore, it is desirable for the C content to be not more than 0.15 mass percent, and more preferably not more than 0.08 mass percent.

Si is a ferrite-forming element, and also contributes to strengthening the matrix solid solution. However, a high Si content readily gives rise to oxide-based inclusions that harm the bending workability, so it is preferable to keep the Si content to not more than 2.0 mass percent.

Mn is an austenite-forming element, and also degrades bending workability by giving rise to oxide-based inclusions. Therefore, it is desirable that the Mn content does not exceed 1.0 mass percent.

Cr is an effective element for enhancing corrosion resistance. To ensure the corrosion resistance of members around the CPU, a Cr content of 10 mass percent or more is desirable. However, too high a Cr content degrades the toughness of the steel, so it is desirable to set the upper limit of the Cr content at 20 mass percent. The preferable Cr content is within the range of 10 to 18 mass percent.

Ni is an austenite-forming element. Too much Ni lowers the Aci point, causing an occurrence of too much martensite phase when cooling during the annealing process, degrading the bending workability. Therefore, it is desirable that the Ni content does not exceed 2 mass percent. In this invention, a certain level of martensite phase may exist that is within the range permitted with respect to the working of the material.

The element Al is added as a deoxidizing agent. To achieve a sufficient deoxidizing effect, an Al content of 0.001 mass percent is desirable. Too high an Al content gives rise to oxide-based inclusions and Al nitride, causing surface flaws and degradation of bending workability. Therefore, it is desirable that the Al content does not exceed 0.05 mass percent, and more preferably that it is within the range of 0.003 to 0.03 mass percent.

Each of the elements Mo, Cu, Ti and Nb contributes to enhancing corrosion resistance and may be added as required. In each case, however, adding too much can degrade bending workability due to the hardening of the matrix caused by the strengthening of the solid solution and increased precipitation of carbides and the like. Therefore, when one, two or more of these elements are added, it is desirable that the amount concerned does not exceed 4 mass percent in the case of Mo, and 2 mass percent in the case of Cu, Ti, and Nb.

Manufacturing Method

Utilizing work hardening by cold rolling is an effective way to impart a suitable rigidity and strength to the CPU socket frame and retention cover. In the case of ferritic stainless steel containing 10 to 20 mass percent Cr, for example, steel sheet having the above-described Young's modulus and 0.2% yield strength can be obtained by adjusting the finish cold-rolling reduction ratio within the range 15 to 50% for a sheet thickness of 0.5 to 1.5 mm.

Specifically, the steel strip can be manufactured by using a process comprising preparing a melt of stainless steel having the above chemical composition, which is then continuously cast and hot rolled to obtain a plate approximately 5 mm thick, box-annealing the plate for 5 to 10 hours at a temperature of from 750 to less than 830° C., followed by cold rolling and one or more annealings comprising soaking for 0 to 5 minutes at from 750 to less than 830° C., and finally, finish cold rolling at a reduction ratio in the range 15 to 50% to form sheet having a thickness of 0.5 to 1.5 mm. Suitable pickling can be performed during the process.

In this way, it is possible to obtain steel sheet in which the Young's modulus in the T direction (steel sheet having the above-described Young's modulus and 0.2% yield strength). The CPU socket frame and retention cover are manufactured by press-forming this steel sheet. In the press-forming, the direction in which the CPU socket frame and retention cover are required to have the high Young's modulus is set to coincide with the T direction of the steel sheet. Mass-production can be carried out by slitting the steel sheet into strips of the required width and transfer-pressing the strips.

### EXAMPLES

A melt of stainless steel having the components shown in Table 1 was prepared and continuously cast to obtain a slab. The slab was then heated to 1200° C. and hot rolled to obtain hot-rolled coil 5 mm thick. This was heated for 7 hours at 800° C. in a box-annealing furnace, then cooled, pickled and cold-rolled at a diferent reduction ratio to obtain seven cold-rolled sheets having a thickness of the range between 0.8 and 1.78 mm. The sheets were annealed by being heated to 800° C. (with zero seconds retention at 800° C.) then rapidly cooled, and after pickling were subjected to finish cold-rolling at a reduction ratio in the range 0 to 55%, adjusted to a sheet thickness of 0.8 mm.

Comparative Example of the conventional austenitic stainless steel SUS301-CPS ½H (0.8 mm thick) was also prepared. The numbers 1 to 7 listed in Table 2 are samples of the stainless steel of Table 1. SUS301 was used for No. 8.

TABLE 1
(In mass percent)

| C | Si | Mn | P | S | Cr | Ni | Al |
|---|---|---|---|---|---|---|---|
| 0.06 | 0.44 | 0.28 | 0.031 | 0.001 | 12.25 | 0.20 | 0.008 |

Test pieces for the tensile test according to JIS Z2201 13B were prepared that were taken from the L direction and T direction of the steel sheet, and the strain gauge method used to measure the Young's modulus in each direction of each test piece subjected to a 0.05% strain. Tensile tests were also carried out on the test pieces according to JIS Z2241 to obtain the 0.2% yield strength in each direction.

Bending workability was investigated using a V-block bend method based on a 90°-V-bend test conforming to JIS Z2248. Using a punch tip with a radius R of 0.2 mm, a test piece was given a 90° bend with respect to two directions: bending axis parallel to the rolling direction (T-direction bend), and bending axis perpendicular to the rolling direction (L-direction bend), and an optical microscope was used to examine the bend portion to see whether any cracking had occurred, and the samples were rated as “Good” (denoted by “◯”) meaning no cracking was observed, or “Defective” (denoted by “X”), meaning cracking was observed.

Except in the case of No. 7, which had poor bending workability, the strips obtained by slitting the steel sheets were transfer-pressed to manufacture a CPU socket frame and retention cover similar in shape to those shown in FIG. 1. For this, the direction corresponding to the side-to-side direction with respect to FIG. 1 (b) was arranged to coincide with the T direction of the steel sheet. Each of the retention covers was formed to have the warp as previously explained. The CPU socket frame from a steel sheet was paired with a retention cover from the same steel sheet to assemble on a motherboard the CPU attachment section having the structure shown in FIG. 1, and a CPU chip mounting test conducted. For this, a pressure-measurement film was placed between the CPU and the socket, and the fixing pressure when the CPU chip was fixed in place and the retention cover closed using the hook was measured. This was referred to fixing pressure. While any fixing pressure that was at least 1.0 MPa could be used, to make the conditions more rigorous, it was decided that the fixing pressure had to be 1.2 MPa or more to pass the test.

With the CPU chip positioned in the socket, the hook was used to close and open the retention cover 1000 times, following which the amount of retention cover warp was compared to the amount of warp before the test. To carry out the measurement, the retention cover was placed on a surface plate with the concave portion downward. The difference between the amount of warp before the test and the amount of warp after the test was obtained and defined herein as the amount of retention cover deformation. To pass the test, the amount of retention cover deformation had to not exceed 300 μm, an amount judged to signify adequate applicability. The results are shown in Table 2.

TABLE 2

| | | | | | | 0.2% Yield | | | | | |
|---|---|---|---|---|---|---|---|---|---|---|---|
| | | Finish | Young's Modulus | | | Strength | | | | | Amount of |
| | | Cold-rolling | L | T | | L | T | Bending | | | Retention |
| | | Reduction | Direction | Direction | | Direction | Direction | Workability | | Fixing | Cover |
| | | Ratio | E_{L} | E_{T} | E_{T} − E_{L} | σ0.2 L | σ0.2 T | L | T | Pressure | Deformation |
| Category | No. | (%) | (GPa) | (GPa) | (GPa) | (MPa) | (MPa) | Direction | Direction | (MPa) | (μm) |
| Inventive | 1 | 15 | 204 | 222 | 18 | 520 | 612 | ◯ | ◯ | 1.2 | 263 |
| Examples | 2 | 20 | 211 | 239 | 28 | 565 | 680 | ◯ | ◯ | 1.4 | 180 |
| | 3 | 30 | 218 | 242 | 24 | 648 | 753 | ◯ | ◯ | 1.5 | 105 |
| | 4 | 50 | 213 | 251 | 38 | 784 | 891 | ◯ | ◯ | 1.7 | 43 |
| Comparative | 5 | 0 | 201 | 203 | 2 | 275 | 274 | ◯ | ◯ | 1.1 | 940 |
| Examples | 6 | 10 | 202 | 210 | 8 | 450 | 522 | ◯ | ◯ | 1.2 | 416 |
| | 7 | 55 | 212 | 250 | 38 | 813 | 911 | ◯ | X | — | — |
| | 8 | 20 | 194 | 198 | 4 | 882 | 810 | ◯ | ◯ | 0.7 | 55 |

As can be seen from Table 2, the examples of the present invention in which the finish cold-rolling reduction ratio was adjusted within the range 15 to 30% satisfied the conditions that the T-direction Young's modulus be 210 GPa or above, the L-direction 0.2% yield strength σ_{0.2L} be 500 to 900 MPa, and the T-direction 0.2% yield strength σ_{0.2T} be 600 to 900 MPa, and registered good results with respect to bending workability, fixing pressure and amount of retention cover deformation. Also, since it was possible to increase the T-direction Young's modulus, the relationship E_{L}≦E_{T}−15 was also satisfied, signifying no problem with respect to transfer-pressing manufacturability.

In contrast, because the steel sheet of Comparative Example No. 5 was used as-annealed, the Young's modulus could not be improved specifically in the T direction and the fixing pressure was low compared to the inventive examples. Also, the 0.2% yield strength was low, so the amount of retention cover deformation was excessive. Due to the insufficient finish cold-rolling reduction ratio in the case of No. 6, the improvement in the 0.2% yield strength was inadequate, resulting in a large amount of retention cover deformation. In the case of No. 7, the reduction ratio was too high, resulting in an excessive T-direction 0.2% yield strength, degrading the bendability in that direction. Conventional SUS301 was used as the material of No. 8, which exhibited a low Young's modulus in both the T direction and the L direction. Therefore, the fixing pressure was low, resulting in a fastening performance that was less reliable than that of the inventive examples. In addition, the material was expensive, due to the fact that it is an austenitic steel with a high Ni content.

1. Stainless steel sheet for a CPU socket frame or CPU retention cover, said stainless steel sheet having a Young's modulus E_{T} in a T direction that is 210 GPa or above, a 0.2% yield strength σ_{0.2L} in an L direction that is from 500 to 900 MPa, and a 0.2% yield strength σ_{0.2T} an T direction that is from 600 to 900 MPa, said L direction being steel sheet rolling direction and said T direction being a direction perpendicular to the rolling direction.

2. The stainless steel sheet according to claim 1, wherein the relationship between the Young's modules E_{L} (GPa) in the L direction and the Young's modules E_{T} (GPa) in the T direction is E_{L}≦E_{T}−15.

3. The stainless steel sheet according to claim 1, wherein the chemical composition of the steel, in mass percent, is C: up to 0.15%, Si: up to 2%, Mn: up to 1%, Cr: 10 to 20%, Ni: up to 2%, Al: 0.001 to 0.05%, Mo: 0 to 4%, Cu: 0 to 2%, Ti: 0 to 2%, Nb: 0 to 2%, with the balance being Fe and unavoidable impurities.

4. The stainless steel sheet according to claim 2, wherein the chemical composition of the steel, in mass percent, is C: up to 0.15%, Si: up to 2%, Mn: up to 1%, Cr: 10 to 20%, Ni: up to 2%, Al: 0.001 to 0.05%, Mo: 0 to 4%, Cu: 0 to 2%, Ti: 0 to 2%, Nb: 0 to 2%, with the balance being Fe and unavoidable impurities.
